(19) United States
(12) Patent Application Publication
(10) Pub. No.: US 2014/0287519 A1
(43) Pub. Date: Sep. 25, 2014

(54) Method, Control Device and Device for Analyzing a Gas

(71) Applicant: Robert Bosch GmbH, Stuttgart (DE)

(72) Inventors: Denis Kunz, Untergruppenbach (DE); Kathy Sahner, Leonberg (DE); Philipp Nolte, Gerlingen (DE)

(73) Assignee: Robert Bosch GmbH, Stuttgart (DE)

(21) Appl. No.: 14/217,627

(22) Filed: Mar. 18, 2014

(30) Foreign Application Priority Data
Mar. 19, 2013 (DE) 10 2013 204 821.1

(51) Int. Cl. G01N 25/32

(52) U.S. Cl. CPC G01N 25/32
USPC 436/160; 422/95

(57) ABSTRACT

A method for analyzing a gas at a heatable element for a lambda probe includes reading a value of a heating power available to the heatable element for maintaining a predetermined temperature of the heatable element, and determining a gas composition of the gas at the heatable element using the value of the heating power.

This application claims priority under 35 U.S.C. §119 to patent application no. DE 10 2013 204 821.1, filed on Mar. 19, 2013 in Germany, the disclosure of which is incorporated herein by reference in its entirety.

### BACKGROUND

The present disclosure relates to a method for analyzing a gas, to a corresponding control device and to a device for analyzing a gas, in particular an exhaust gas of an internal combustion engine of a vehicle.

In order to be able to adapt a ratio between a quantity of fuel for a combustion process and an available quantity of oxygen, definitive information is required about an oxygen concentration in an exhaust gas of the combustion process.

DE 199 41 051 A1 describes a sensor element for determining the oxygen concentration in gas mixtures and a method for manufacturing same.

### SUMMARY

Against this background, the present disclosure presents a method for analyzing a gas at a heatable element for a lambda probe, a corresponding control device and a device for analyzing a gas. Advantageous refinements can be found in the claims and the following description.

Given stable ambient conditions, a change in a composition of a gas influences the transfer of heat between a heated object and the gas. The transfer of heat for known compositions of the gas given a known temperature of the object can be measured empirically as a reference. If a quantity of heat which is picked up at a particular time by the gas per time unit and the temperature of the object are known, it is possible to draw conclusions about the current composition.

A method is presented for analyzing a gas at a heatable element for a lambda probe, wherein the method comprises the following steps:

reading in a value of a heating power, made available to the heatable element, for maintaining a predetermined temperature of the heatable element; and

determining a gas composition of the gas at the heatable element using the value of the heating power.

A heatable element can be designed to convert electrical energy into thermal energy. The heatable element can have an electrical conductor which has an electrical resistance. The heatable element can have a known surface for outputting heat. A heating power can be understood to be a power which is conducted to the heatable element in order to heat the heatable element or to maintain a temperature of the heatable element. The heating power can be made available in the form of electrical energy. The heating power which is made available to the heatable element can be output to the gas by the heatable element. The heating power can be proportional to thermal power which is absorbed by the gas at the heatable element. A predefined temperature can be a temperature determined by trials. Physical variables of the gas can be given or known. For example, a flow speed of the gas and alternatively or additionally a temperature of the gas can be known. For example, a fixed flow speed can be given by a restrictor through which the gas can be conducted.

In the reading in step, the value of the heating power of a heatable element which is arranged in a combustion exhaust gas can be read in. The method can therefore be used, for example, to analyze a stream of exhaust gas of a motor vehicle. Alternatively or additionally, in the determining step a combustion air ratio of the gas can be determined as the gas composition. A combustion exhaust gas can be an exhaust gas of an internal combustion engine. A combustion air ratio can characterize an excess or a lack of oxygen which is necessary for the combustion. If the combustion air ratio is compensated, all reaction partners can be converted completely to reaction products.

The value of the heating power can be determined by the heatable element using an electrical voltage which drops across the heatable element and an electrical current flow. This permits very easy determination of the value of the heating power.

The method can comprise a step of making available the heating power for the heatable element, wherein the heating power is made available until a value of an electrical resistance of the heatable element is within a tolerance range about a setpoint resistance which is assigned to the predetermined temperature. This can involve a setpoint resistance of the heatable element. The reading in step can take place when the electrical resistance is within the tolerance range about the setpoint resistance. The heating power can be variable. The heating power can be regulated with the setpoint resistance as a reference variable. The electrical resistance can be referred to as a control variable. The electrical resistance can be proportional to a temperature of the heatable element. The temperature can be regulated indirectly by means of the electrical resistance.

In the reading in step, a value of a temperature of the gas can also be read in at the heatable element. The gas composition can also be determined using the value of the temperature and of a relationship between the temperature and the heating power. The temperature can be measured, for example, by a temperature sensor. The temperature can be detected using a temperature-dependent electrical resistance of the heatable element when the element is unheated. The heating and the measuring can therefore take place alternately. The relationship can be stored in a characteristic diagram. The relationship can be represented in a formula. The relationship may have been determined in reference measurements.

In the reading in step, a value of a flow speed of the exhaust gas can also be read in at the heatable element. The gas composition can also be determined using the value of the flow speed and a relationship between the flow speed and the heating power. The temperature can be measured, for example, by a temperature sensor. The flow speed can be detected by means of a sensor. The relationship can be stored in a characteristic diagram. The relationship can be represented in a formula. The relationship may have been determined in reference measurements.

The flow speed can be determined using a mass flow of the gas through a known flow cross section. The flow speed can be proportional to the mass flow by virtue of fluid mechanics relationships. The mass flow can be detected by means of a sensor.

A control device for analyzing a gas at a heatable element for a lambda probe is presented, wherein the control device comprises the following features:

a device for reading in a value of a heating power, made available to the heatable element, for maintaining a predetermined temperature of the heatable element; and

a device for determining a gas composition of the gas at the heatable element using the value of the heating power.

A control device can be understood here to be an electrical device which processes sensor signals and outputs control signals and/or data signals as a function thereof. The control device can have an interface which can be embodied by means of hardware and/or software. In the case of a hardware embodiment, the interfaces may be, for example, part of what is referred to as a system ASIC, which includes a wide variety of functions of the control device. However, it is also possible for the interfaces to be separate integrated circuits or to be composed at least partially of discrete components. In the case of a software embodiment, the interfaces can be software modules which are present, for example, on a microcontroller alongside other software modules.

Furthermore, a device for analyzing a gas is presented, wherein the device comprises the following features:

a lambda probe having a heatable element for arrangement in a stream of exhaust gas; and

a control device according to the approach presented here.

A computer program product having program code which can be stored on a machine-readable carrier such as a semiconductor memory, a hard disk memory or an optical memory is also advantageous and is used to carry out the method according to one of the embodiments described above when the program product is run on a computer or a device.

### BRIEF DESCRIPTION OF THE DRAWINGS

The disclosure will be explained in more detail below by way of example with reference to the appended drawings, in which:

FIG. 1 shows a block circuit diagram of a device for analyzing a gas according to an exemplary embodiment of the present disclosure; and

FIG. 2 shows a flowchart of a method for analyzing a gas according to an exemplary embodiment of the present disclosure.

### DETAILED DESCRIPTION

In the following description of preferred exemplary embodiments of the present disclosure, identical or similar reference symbols are used for similarly acting elements which are presented in the various figures, wherein a repeated description of these elements is not given.

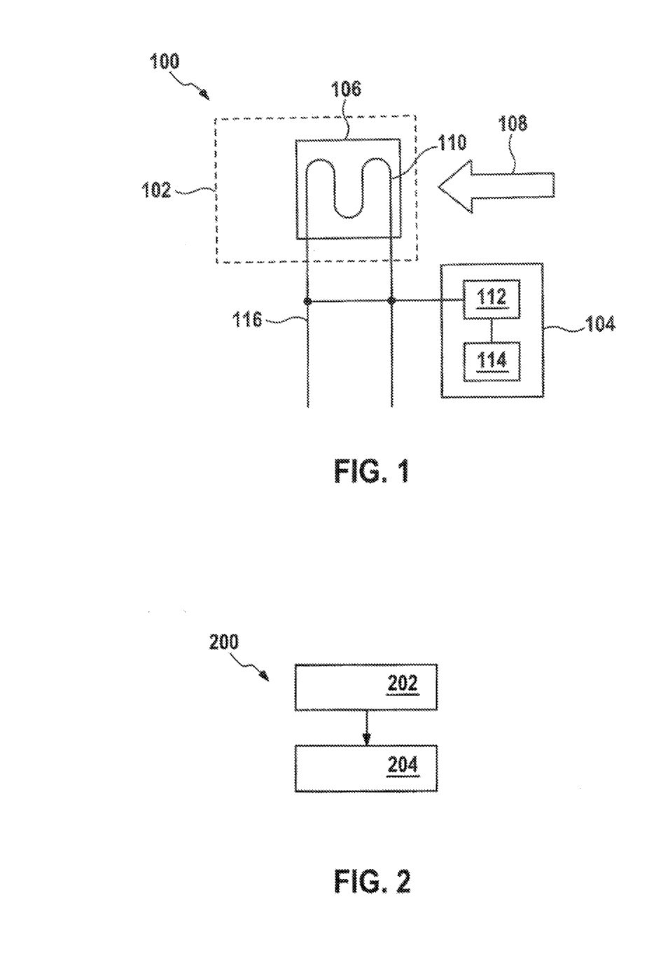

FIG. 1 shows a block circuit diagram of a device 100 for analyzing a gas according to an exemplary embodiment of the present disclosure. The device 100 has a lambda probe 102 and a control device 104. The lambda probe 104 has a heatable element 106 for arrangement in a stream 108 of exhaust gas. The heatable element 106 has a meander 110 composed of an electrical conductor which has, for example, an ohmic resistance. The resistance of the electrical conductor can alternatively also deviate from Ohm's Law. The relationship between the resistance and the temperature can, but does not have to be, linear with the temperature. The meander 110 is designed to heat the heatable element 106 over a surface when an electrical current flows through the meander. The heatable element 106 is arranged in such a way that the stream 108 of exhaust gas can flow over it in order to absorb heat from the heatable element 106, that is to say to cool the heatable element 106.

The control device 104 has a reading in device 112 and a determining device 114. The reading in device 112 is designed to read in a value of a heating power which is made available to the heatable element 106, in order to maintain a predetermined temperature of the heatable element. For this purpose, the reading in device 112 is connected to an electrical connecting line 116 of the heatable element 106. At the connecting line 116, the reading in device 112 can detect an electrical voltage which drops across the heatable element 106 and an electrical current which flows through the heatable element 106, and can determine the value of the heating power on the basis thereof. The detection can take place in a contactless fashion. The determining device 114 is designed to determine a gas composition of the gas 108 at the heatable element 106 using the value of the heating power. The control device 104 can also be integrated into the lambda probe 102. For example as an integrated circuit 104 which has been formed on a chip of the lambda probe 102 using semiconductor-technical fabrication methods.

According to one exemplary embodiment, a lambda probe 102 is used to measure a residual oxygen content or deficit in a combustion exhaust gas 108. In this context, a flow in an electrochemical pump cell is used to evaluate the gas signal in a lambda probe 102 in the form of a broadband probe. A cell voltage is evaluated in a lambda probe 102 in the form of a discrete-level sensor 102. The current and voltage are respectively characteristic of the λ value of the combustion gas 108. In the case of broadband probes 102, a large lambda range can be measured, typically between λ=0.8 and λ=1.7 or even larger. In the case of discrete-level sensors 102, the measuring range in the range about λ=1 can be measured with high accuracy, and in the case of significant deviations from lambda=1 it is only evaluated whether the exhaust gas 108 is in the lean (λ>1) or in the rich (λ<1) region.

As a result of the approach presented here, information from a heatable element 106 in the form of a probe heater 106 can be used to evaluate lambda in a combustion gas 108. In addition to the previous probe signal information from the heater 106 can be used to measure λ. As a result, in particular in the case of discrete-level sensors 102 the measuring range can be extended.

In the case of the probes 102 described, the temperature of the sensor element is achieved by regulating the heater 106 in such a way that a selective resistance is set and maintained at the electrolyte of the lambda probe 102.

The necessary heating power (or a current and voltage, the third variable results from two of these variables respectively), depends directly on the heat absorption of the gas 108 to be measured. The heat absorption depends in turn on the gas composition. The gas composition, that is to say the percentage composition composed of CO₂, N₂, water, CO, H₂, oxygen, . . . is characteristic of the respective application. However, at every λ value the composition of the gas 108 is different, and therefore also the conduction of heat. Therefore, in a given application the heating power is a measure of λ.

Further influencing variables acting on the heating power may be the mass flow of exhaust gas and the temperature of the exhaust gas. This information can be supplied by further sensors or other information from the vehicle. λ can in turn be determined from a characteristic diagram which is measured for the application. The characteristic diagram can represent a relationship of the mass flow of exhaust gas and/or the temperature of the exhaust gas with λ and the heating power.

The design of the lambda probe 102 remains unchanged here. However, in the evaluation circuit 104 the power for the heater system 106 can be measurable, i.e. by measuring the current and voltage.

Information can also be used in a program code of the operating software of the evaluation electronics.

The approach presented here can be used for gas sensors 102 for characterizing the residual oxygen content in combustion gases, in particular with the function as a discrete-level lambda sensor 102. In the case of broadband probes 102 it is possible to extend the measuring range, for example in the case of very small λ values outside the measuring range of the electrochemical pump cell. The approach presented here can be used both for the current generation of sensors 102 on the basis of thick-film technology, and also used, for example, in future generations on the basis of thin-film ion conductors.

FIG. 2 shows a flowchart of a method 200 for analyzing a gas according to an exemplary embodiment of the present disclosure. The method 200 can be used at a heatable element for a lambda probe such as is illustrated in FIG. 1. The method 200 can be carried out in a control device as in FIG. 1. The method 200 has a reading in step 202 and determining step 204. In the reading in step 202, a value of a heating power which is made available to the heatable element, for maintaining a predetermined temperature of the heatable element, is read in. In the determining step 204, a gas composition of the gas at the heatable element is determined using the value of the heating power.

The described exemplary embodiments shown in the figures are selected only by way of example. Different exemplary embodiments can be combined with one another completely or with respect to individual features. It is also possible for one exemplary embodiment to have features of a further exemplary embodiment added to it. In addition, inventive method steps can be repeated and carried out in another sequence than that described.

If an exemplary embodiment comprises an “and/or” conjunction between a first feature and a second feature, this is understood as meaning that the exemplary embodiment according to one embodiment has both the first feature and the second feature, and according to a further embodiment has either only the first feature or only the second feature.

What is claimed is:

1. A method of analyzing a gas at a heatable element for a lamda probe, comprising:
reading in a value of a heating power available to the heatable element, wherein the heating power is configured to maintain a predetermined temperature of the heatable element; and
determining a gas composition of the gas at the heatable element using the value of the heating power.

2. The method of analyzing a gas according to claim 1, wherein at least one of:
the heating element is positioned in a combustion exhaust gas during the reading in; and
the method further comprises determining a combustion air ratio of the gas.

3. The method of analyzing a gas according to claim 1, wherein the reading in further includes determining the value of the heating power using an electrical voltage that drops across the heatable element and an electrical current flow through the heatable element.

4. The method of analyzing a gas according to claim 1, further comprising providing the heating power for the heatable element until a value of the electrical resistance of the heatable element is within a tolerance range about a value of a setpoint resistance assigned to the predetermined temperature, wherein the sepoint resistance is assigned to the predetermined temperature during the reading in when the value of the electrical resistance is within the tolerance range.

5. The method of analyzing a gas according to claim 1, further comprising reading in a value of a temperature of the gas at the heatable element, wherein the determining of the gas composition is based at least in part upon the value of the temperature and a relationship between the temperature and the heating power.

6. The method of analyzing a gas according to claim 1, further comprising reading in a value of a flow speed of the gas at the heatable element, wherein the determining of the gas composition is based at least in part upon the value of the flow speed and a relationship between the flow speed and the heating power.

7. The method of analyzing a gas according to claim 6, wherein the reading in of the value of the flow speed includes determining the flow speed using a mass flow of the gas through a known flow cross section.

8. A control device for analyzing a gas at a heatable element for a lambda prove, comprising:
a device configured to read in a value of a heating power provided to the heating element for maintaining a predetermined temperature of the heatable element; and
a device configured to determine a gas composition of the gas at the heatable element based at least in part upon the value of the heating power.

9. A device for analyzing a gas comprising:
a lamda probe that includes a heatable element and is configured to be positioned in a stream of exhaust gas; and
a control device that includes
a device configured to read in a value of a heating power provided to the heating element for maintaining a predetermined temperature of the heatable element; and
a device configured to determine a gas composition of the gas at the heatable element based at least in part upon the value of the heating power.
